(19) United States
(12) Patent Application Publication
(10) Pub. No.: US 2020/0297006 A1
(43) Pub. Date: Sep. 24, 2020

(54) HEATED PRODUCT SALES SYSTEM

(71) Applicant: SHARP KABUSHIKI KAISHA, Sakai City (JP)

(72) Inventors: ATSUTADA FUKUMORI, Sakai City (JP); AKIO IIJIMA, Sakai City (JP); YOSHINOBU TOMOMURA, Sakai City (JP); YURI KURAMOCHI, Sakai City (JP)

(21) Appl. No.: 16/822,995

(22) Filed: Mar. 18, 2020

(30) Foreign Application Priority Data
Mar. 22, 2019 (JP) 2019-054218

(51) Int. Cl. A23L 5/10; G06Q 50/12; G06Q 20/20; A23L 5/30

(52) U.S. Cl. CPC A23L 5/15; A23L 5/34; G06Q 20/203; G06Q 50/12

(57) ABSTRACT

A heated product sales system includes a first apparatus configured to heat and cook a product; and a second apparatus configured to suspend a sale of the product until a certain time period has elapsed after the heating and cooking.

### CROSS-REFERENCE TO RELATED APPLICATION

The present application claims priority from Japanese Application JP2019-54218, the content to which is hereby incorporated by reference into this application.

### BACKGROUND OF THE DISCLOSURE

### Field of the Disclosure

The present disclosure relates to a heated product sales system which involves heating a product and selling the heated product.

### Description of the Background Art

A known service involves heating and cooking a product and selling the cooked product. For example, as to the systems disclosed in Japanese Unexamined Patent Application Publication Nos. H10-040457 (Patent Document 1) and 2007-200193 (Patent Document 2), the products are likely to be on sale as soon as heating of the products ends. Hence, the systems are not applicable to food products suitable to be sold at a room temperature.

Moreover, such conventional systems as disclosed in Patent Documents 1 and 2 include a heating system and a sales system combined together, allowing for collective control up to sales. Because of the combined system, the apparatuses for the system become larger, making it difficult to install the apparatuses in a retail store. Furthermore, in order to solve the problem, the system could be downsized and the heating system and the sales system could be separated from each other. In this case, however, the heating system and the sales system cannot cooperate with each other, and the products on sale might be unevenly heated to a large extent.

The present disclosure is intended to reduce the risk that a product on sale is unevenly heated to a large extent.

### SUMMARY

An aspect of the present disclosure provides a heated product sales system including: a first apparatus heating and cooking a product; and a second apparatus suspending a sale of the product until a certain time period has elapsed after the heating and cooking.

As can be seen, the present disclosure can reduce the risk that a product on sale is unevenly heated to a large extent.

### BRIEF DESCRIPTION OF THE DRAWINGS

FIG. 1 schematically illustrates a heated product sales system according to a first embodiment;

FIG. 2 schematically illustrates an operation of the heated product sales system according to the first embodiment;

FIG. 3 illustrates second printed labels according to the first embodiment;

FIG. 4 illustrates a block diagram illustrating a configuration of a heating apparatus according to the first embodiment;

FIG. 5 illustrates a heating information table according to the first embodiment;

FIG. 6 illustrates a “settling” end information table according to the first embodiment;

FIG. 7 illustrates a product information table according to the first embodiment;

FIG. 8 illustrates a flowchart showing information processing on the heating apparatus according to the first embodiment;

FIG. 9 illustrates a block diagram illustrating a configuration of a label printing system according to the first embodiment;

FIG. 10 illustrates a flowchart showing information processing on the label printing system according to the first embodiment;

FIG. 11 illustrates a block diagram showing a configuration of a point-of-sales (POS) system according to the first embodiment;

FIG. 12 illustrates a flowchart showing information processing on the POS system according to the first embodiment;

FIG. 13 illustrates an example of second printed labels according to a second embodiment;

FIG. 14 illustrates a flowchart showing information processing on the heating apparatus according to the second embodiment;

FIG. 15 illustrates a flowchart showing information processing on the label printing system according to the second embodiment;

FIG. 16 illustrates a flowchart showing information processing on the POS system according to the second embodiment;

FIG. 17 illustrates a flowchart showing information processing on the label printing system according to a third embodiment; and

FIG. 18 schematically illustrates a heated product sales system according to a fourth embodiment.

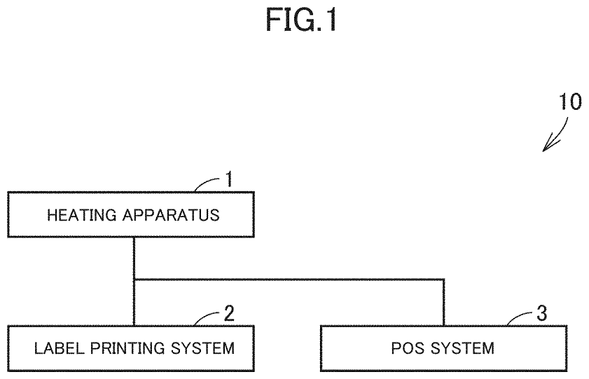

### DESCRIPTION OF THE PREFERRED EMBODIMENTS

Described below are embodiments of the present disclosure with reference to the drawings. In the descriptions below, identical reference signs are used to denote identical components. The identical components share the same name and function. Hence, detailed descriptions of the identical components shall not be repeated.

### First Embodiment

Described first is an overall configuration of a heated product sales system 10 according to a first embodiment. The heated product sales system 10 according to this embodiment includes: a heating apparatus 1 such as a microwave oven for heating a product; a label printing system 2 for printing a second label to be attached on the product; and a POS system 3 for managing a sale of the product.

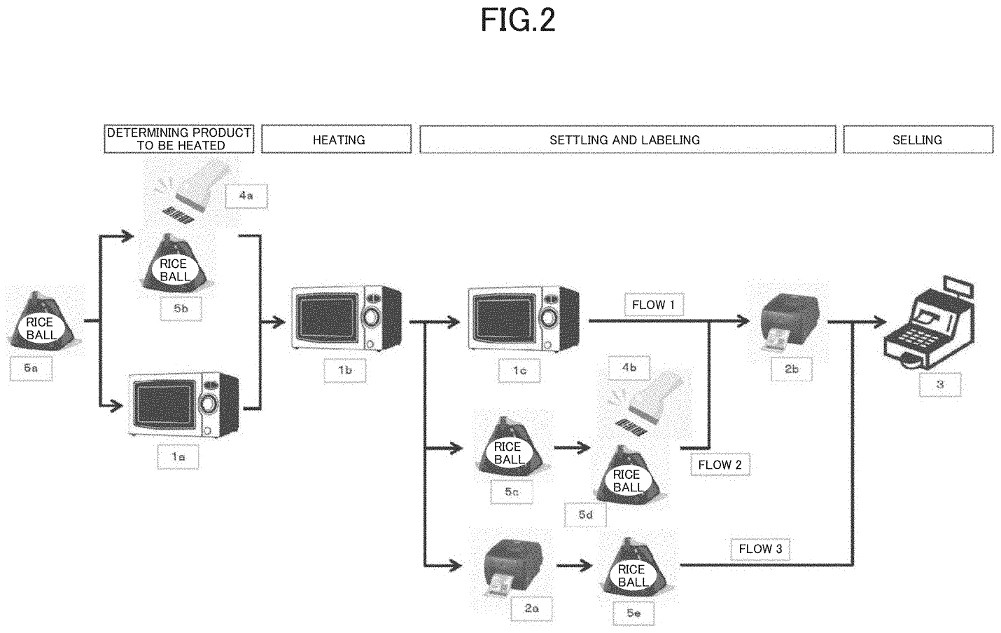

Schematically described next is an operation of the heated product sales system 10 according to the first embodiment, with reference to the illustration “flow 1” in FIG. 2.

First, the heating apparatus 1 either receives information on a product 5 through a button on a body of the heating apparatus 1 or obtains the information in a first label attached on the product 5 through a bar-code reader connected to the heating apparatus 1. The heating apparatus 1 then determines a kind of the product 5 to be heated. When determining the kind of the product 5, the heating apparatus 1 uses information stored in an internal storage apparatus inside the heating apparatus 1 or an external storage apparatus.

Then, depending on the determined kind of the product 5, the heating apparatus 1 reads out heating information including, for example, a heating time period, a power level, and a “settling” time period. Note that, as the heating information, the heating apparatus 1 uses information stored in the internal storage apparatus inside the heating apparatus 1 or an external storage apparatus. Moreover, the “settling time” is a time period required between the end of the heating and cooking and a time point when the product has a uniform temperature distribution to some extent.

The heating apparatus 1 sets a timer for the read out heating time period, and heats the product 5 with the read out power level. When the heating time period elapses, the heating apparatus 1 stops heating, and sets the timer for the read out “settling” time period.

When the “settling time” elapses, the heating apparatus 1 transmits to the label printing system 2 a kind of the heated product and end information as “settling” end information. The information may be transmitted either through wire or wirelessly.

When receiving the “settling” end information, the label printing system 2 reads out product information including a kind, a price, and a sales time period of the product. Note that, as the product information, the label printing system 2 uses information stored in an internal storage apparatus inside the label printing system 2 or an external storage apparatus.

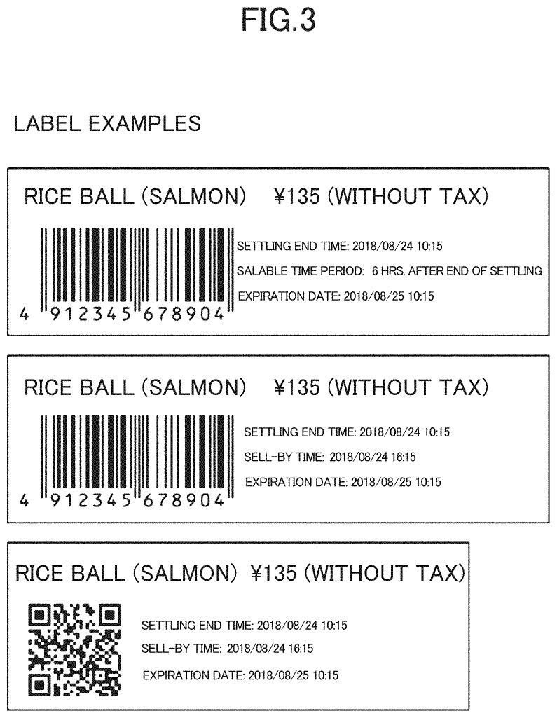

Based on the read out product information, the label printing system 2 prints a second label illustrated, for example, in FIG. 3. The printed second label is attached to the product 5 by, for example, a sales clerk, and the product 5 is displayed in a store.

When the product 5 is picked up by a customer and scanned through the POS system 3, the POS system 3 reads out the product information including the kind, the price, and the salable time period of the product 5. The salable time period is, for example, a time period from when the product 5 is heated and “settled” until the product 5 becomes excessively cold and hard. As the product information, the POS system 3 uses information stored in an internal storage apparatus inside the POS system 3 or an external storage apparatus.

The POS system 3 compares the read out sales time period with a current time to check a sell-by time. If the product is within the sell-by time, the product is allowed to be on sale. If the product is out of the sell-by time, the POS system 3 issues a warning and does not permit a casher to sale the product.

As can be seen, the heated product sales system 10 issues a permission to sell the product after a certain time period has passed since the end of heating the product. Such a feature makes it possible to reduce the risk of selling the product whose temperature unevenly distributes immediately after the heating and has not uniformly distributed yet, and to improve quality of the product.

Moreover, the heating system such as the heating apparatus 1 and the sales system such as the label printing system 2 and the POS system 3 are separated from each other as independent systems. Such a feature makes it possible to downsize each system to be placed in a retail store.

Moreover, the heated product sales system 10 allows for sharing heating information of a heated product, reducing the risk that an unheated product is inadvertently to be sold.

Moreover, the second label is printed with at least one or more of the information items; namely, the time period from the end of heating until the temperature of the product is uniformly distributed (the “settling” time period), the information indicating the time when the heating ends, the information indicating an elapse of the “settling” time period, and the salable time period from the end of the “settling” time period or the time when the salable time period ends. Such a feature makes it possible to reduce the risk that the retail store sells an unheated product or a product whose temperature unevenly distributes immediately after the heating and has not uniformly distributed yet, and to improve quality of the product. Furthermore, a customer can make sure approximately what time the unevenly distributed temperature immediately after the heating is uniformly distributed, contributing to determining the right time to eat.

Described below are detailed explanations of the apparatuses constituting the heated product sales system 10.

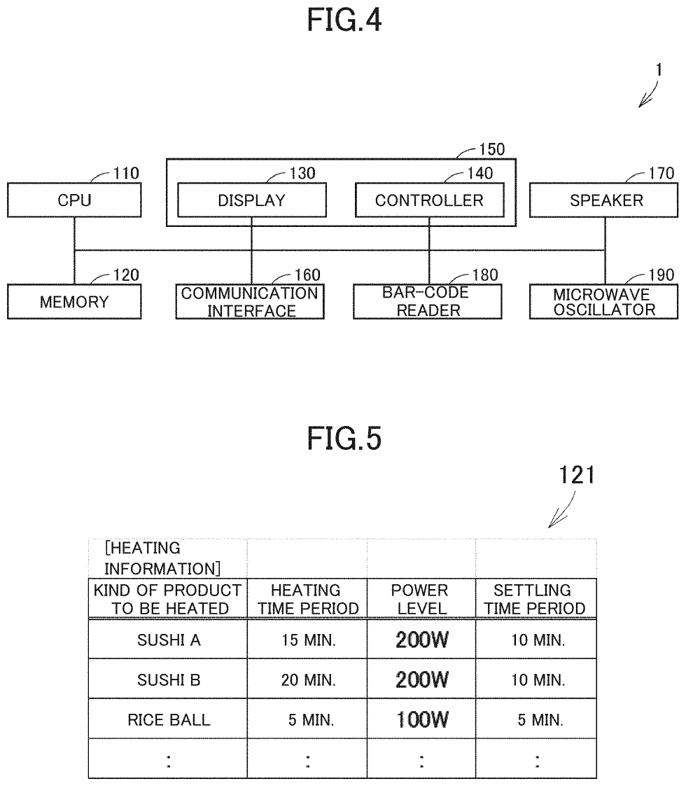

Described first is the heated product sales system 10. As illustrated in FIG. 4, the heating apparatus includes as main components: a CPU 110; a memory 120; a display 130; a controller 140; a communication interface 160; a speaker 170; a various sensors such as a bar-code reader 180; and a microwave oscillator 190.

The CPU 110 executes a program stored in the memory 120 or an external storage medium to control the components of the heating apparatus 1.

The memory 120 is a RAM or a ROM in various kinds. The memory 120 may be contained in the heating apparatus 1, attachable to various interfaces of the heating apparatus 1, and provided as a storage medium for another apparatus accessible from the heating apparatus 1. The memory 120 stores the program to be executed by the CPU 110 and various data. The various data includes: data generated when the CPU 110 executes the program; data input through the controller 140; and data received from another apparatus through a router and the Internet.

Specifically, the memory 120 in this embodiment stores a heating information table 121 illustrated in FIG. 5. For each kind of products, the heating information table 121 stores a corresponding relationship between a product name, a power level and a “settling” time period.

Note that the heating information table 121 may be stored in the POS system 3 and the label printing system 2. Alternatively, the heating information table 121 may be stored in a server to be described later.

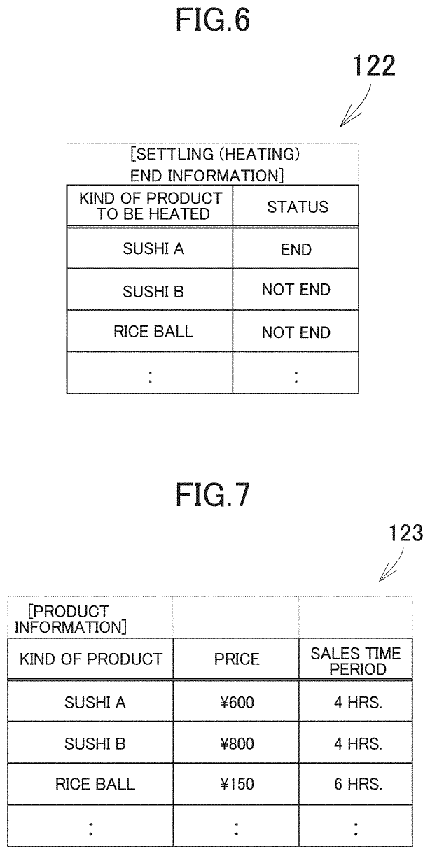

Furthermore, the memory 120 stores a “settling” end information table 122 illustrated in FIG. 6. For each product heated by the heating apparatus 1, the “settling” end information table 122 stores information indicating whether the “settling” time period has elapsed or has not elapsed yet. Note that the “settling” end information table 122 may be stored in the POS system 3 and the label printing system 2. Alternatively, the “settling” end information table 122 may be stored in the server to be described later.

Furthermore, the memory 120 stores a product information table 123 illustrated in FIG. 7. For each kind of products, the product information table 123 stores a corresponding relationship between a product name, a price, and a sales time period. Note that the product information table 123 may be stored in the POS system 3 and the label printing system 2. Alternatively, the product information table 123 may be stored in the server to be described later.

Back to FIG. 4, the display 130 outputs a character and an image based on a signal from the CPU 110.

The controller 140, including a button and a touch panel, receives a command from a user and inputs the command in the CPU 110. Note that the display 130 and the controller 140 may be included in a touch panel 150.

The communication interface 160 is a communication module such as a wireless LAN or a wired LAN. The communication interface 160 exchanges data with another apparatus by wireless or wireline communications through a router and the Internet. Note that the wireless communications may include direct communications among devices through Bluetooth (registered). That is, the CPU 110 transmits information on the received product 5 and information indicating a current operation status to another apparatus through the communication interface 160. Alternatively, the CPU 110 receives various kinds of information such as a control command and audio data from another apparatus through the communication interface 160.

The speaker 170 outputs various kinds of audio based on the audio data from the CPU 110.

The various sensors such as the bar-code reader 180 include a CMOS sensor and an infrared sensor. The sensors read bar-code information attached to the product 5 and measure a temperature of the product 5, and input the read information and the measured temperature in the CPU 110.

In accordance with a command from the CPU 110, the microwave oscillator 190 causes a microwave having a predetermined frequency to oscillate to heat and cook the product 5.

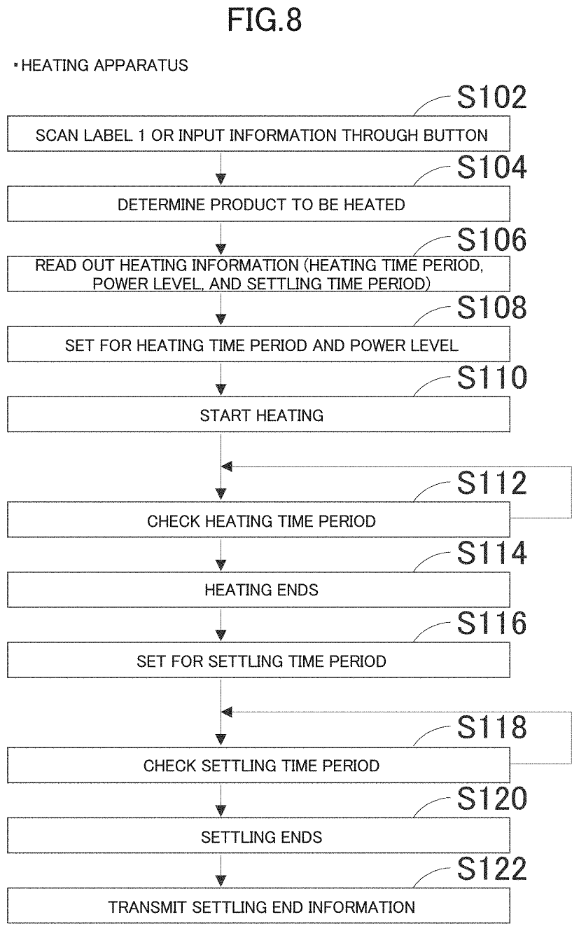

Described next is information processing on the heating apparatus 1 according to this embodiment. As illustrated in FIG. 8, the CPU 110 of the heating apparatus 1 obtains information on a product to be heated through the controller 140 or using the bar-code reader 180 (Step S102). Based on the obtained information, the CPU 110 identifies a kind of the product 5 (Step S104).

With reference to the heating information table 121, the CPU 110 identifies a heating time period and a power level for the product 5 (Step S106). The CPU 110 sets the microwave oscillator 190 for the heating time period and the power level (Step S108). The CPU 110 causes the microwave oscillator 190 to start heating (Step S110).

Until the heating time period ends, the CPU 110 controls the microwave oscillator 190 (Step S112). When the heating time period ends, the CPU 110 causes the microwave oscillator 190 to stop heating (Step S114).

With reference to the heating information table 121, the CPU 110 identifies a “settling” time period and makes setting for the “settling” time period (Step S116). Here, the CPU 110 may inform the POS system 3 and the label printing system 2 through the communication interface 160 that the product 5 is in a “settling” status.

The CPU 110 stands by until the “settling” time period has elapsed (Step S118). When the “settling” time period elapses (Step S120), the CPU 110 informs the POS system 3 and the label printing system 2 through the communication interface 160 of the time when the heating and cooking ends, the “settling” time period, and the product information (Step S122).

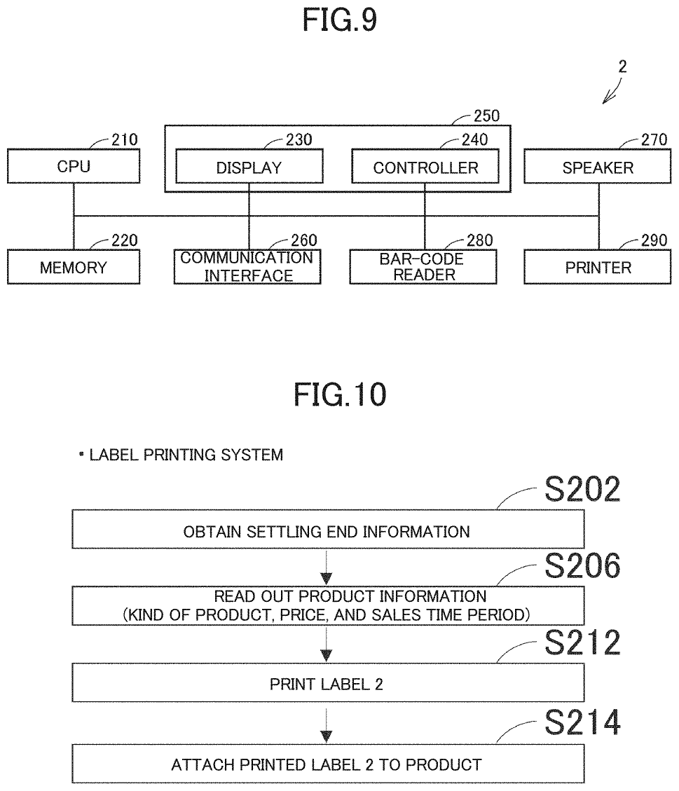

Described next is the label printing system 2. As illustrated in FIG. 9, the label printing system 2 includes as main components: a CPU 210; a memory 220; a display 230; a controller 240; a communication interface 260; a speaker 270; various sensors such as a bar-code reader 280; and a printer 290.

The CPU 210 executes a program stored in the memory 220 or an external storage medium to control the components of the label printing system 2.

The memory 220 is a RAM or a ROM in various kinds. The memory 220 may be contained in the label printing system 2, attachable to various interfaces of the label printing system 2, and provided as a storage medium for another apparatus accessible from the label printing system 2. The memory 220 stores the program to be executed by the CPU 210 and various data. The various data includes: data generated when the CPU 210 executes the program; data input through the controller 240; and data received from another apparatus through a router and the Internet.

The display 230 outputs a character and an image based on a signal from the CPU 210.

The controller 240, including a button and a touch panel, receives a command from the user and inputs the command in the CPU 210. Note that the display 230 and the controller 240 may be included in a touch panel 250.

The communication interface 260 is a communication module such as a wireless LAN or a wired LAN. The communication interface 260 exchanges data with another apparatus by wireless or wireline communications through a router and the Internet. That is, the CPU 210 receives a command from another apparatus such as the heating apparatus 1 and the POS system 3 through the communication interface 260. Then, based on the command, the CPU 210 causes the printer 290 to print a label.

The speaker 270 outputs various kinds of audio based on the audio data from the CPU 210.

The bar-code reader 280 reads bar-code information in the first label attached to the product 5, and inputs the read bar-code information in the CPU 210. The CPU 210 may identify the product 5, and, with reference to the “settling” end information table 122, determine whether the heating and the “settling” for the product 5 has ended.

In accordance with the command from the CPU 210, the printer 290 prints a predetermined text message and image on the second label to be attached to the product 5.

Described next is information processing on the label printing system 2 according to this embodiment. As illustrated in FIG. 10, the CPU 210 of the label printing system 2 obtains the “settling” end information from the heating apparatus 1 through the communication interface 260 (Step S202). With reference to the product information table 123, the CPU 210 reads out the product information on the product 5 heated by the heating apparatus 1 (Step S206).

The CPU 210 causes the printer 290 to print the second label with such information as the kind of the product, the time when the “settling” time period ends, the salable time period since the end of the “settling” time period, and the expiration date (Step S212). The sales clerk attaches the printed second label to the product 5 with the heating and the “settling” completed (Step S214).

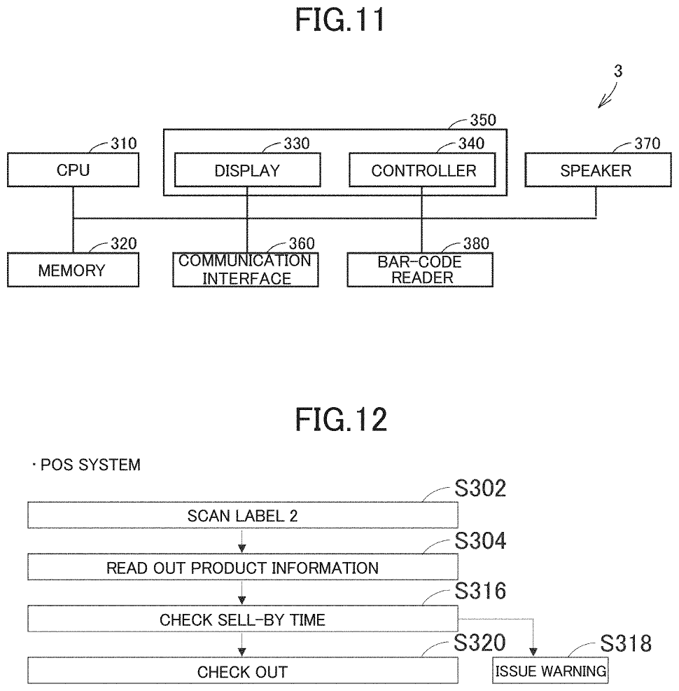

Described next is the POS system 3. The POS system 3 includes a cash register and a bar-code reader. As illustrated in FIG. 11, the POS system 3 in this embodiment includes as main components: a CPU 310; a memory 320; a display 330; a controller 340; a communication interface 360; a speaker 370; and various sensors such as a bar-code reader 380, and an IC card reader.

The CPU 310 executes a program stored in the memory 320 or an external storage medium to control the components of the POS system 3.

The memory 320 is a RAM or a ROM in various kinds. The memory 320 may be contained in the POS system 3, attachable to various interfaces of the POS system 3, and provided as a storage medium for another apparatus accessible from the POS system 3. The memory 320 stores the program to be executed by the CPU 310 and various data. The various data includes: data generated when the CPU 310 executes the program; data input through the controller 340; and data received from another apparatus through a router and the Internet.

The display 330 outputs a character and an image based on a signal from the CPU 310.

The controller 340, including a button and a touch panel, receives a command from the user and inputs the command in the CPU 310. Note that the display 330 and the controller 340 may be included in a touch panel 350.

The communication interface 360 is a communication module such as a wireless LAN or a wired LAN. The communication interface 360 exchanges data with another apparatus by wireless or wireline communications through a router and the Internet.

The speaker 370 outputs various kinds of audio based on the audio data from the CPU 310.

The bar-code reader 380 reads a bar code on the second label attached to the product 5, and inputs in the CPU 310 various kinds of information on the product 5.

Described next is information processing on the POS system 3 according to this embodiment. As illustrated in FIG. 12, the CPU 310 of the POS system 3 reads the bar code of the second label through the bar-code reader 380 (Step S302) to obtain various kinds of information on the product 5 (Step S304).

With reference to the product information table 123 and the information read from the bar code, the CPU 310 reads the salable time period of the product 5, and determines whether the salable time period or the sell-by time of the product 5 has passed (Step S316). If the salable time period has passed, the CPU 310 causes the display 330 to issue a warning message, and the speaker 370 to output a warning tone (Step S318).

If the salable time period has not passed yet, the CPU 310 accepts the purchase of the product 5 so that the check-out of the product 5 ends (Step S320).

### Second Embodiment

In the above first embodiment, the product stands by in the heating apparatus 1 until the “settling” time period ends. However, the operation of the heated product sales system 10 shall not be limited to that in the first embodiment. When the heating apparatus 1 finishes heating in this embodiment, the product 5 is provided with the second label printed with the “settling” time period and a time when the “settling” time period ends. Such a label allows a casher to determine whether the “settling” time period ends when the casher sells the product to a customer.

Described below is a second embodiment with reference the “flow 2” in FIG. 2. The second embodiment is different in flow of the processing from the first embodiment. Note that the configurations of the heating apparatus 1, the label printing system 2, and the POS system 3 in the second embodiment are the same as those in the first embodiment, and the descriptions thereof shall not be repeated.

First, a kind of the product 5 is determined, using an operating button on the body of the heating apparatus 1 or a bar-code reader connected to the heating apparatus 1. In the determination, the heating apparatus 1 uses information on the product stored in an internal storage apparatus inside the heating apparatus 1 or an external storage apparatus.

Then, depending on the determined kind of the product 5, the heating apparatus 1 reads out: heating information including, for example, a heating time period, a power level, and a “settling” time period of the determined product; and product information including a kind, a price, and a sales time period of the product. As the heating information and the product information, the heating apparatus 1 uses information stored in an internal storage apparatus inside the heating apparatus 1 or an external storage apparatus.

The heating apparatus 1 sets a timer for the read out heating time period, and heats the product 5 with the read out power level. When the heating time period elapses, the heating apparatus 1 stops heating, and transmits heading end information, the “settling” time period, and the product information to the label printing system 2. The information may be transmitted either through wire or wirelessly.

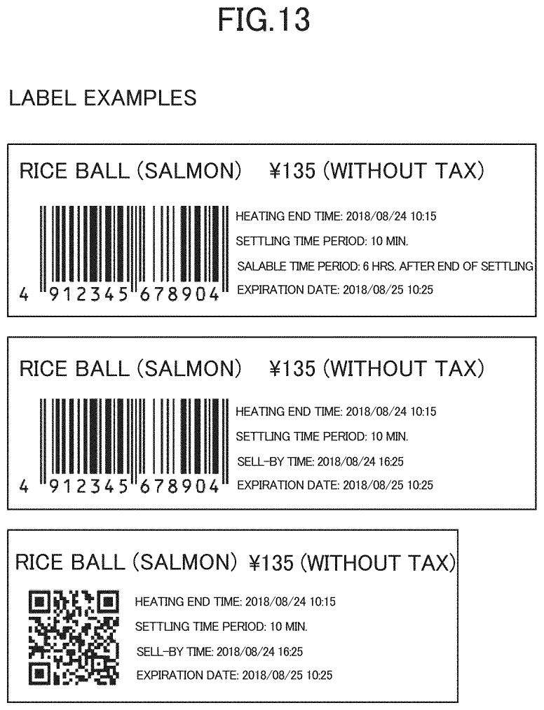

When receiving the heating end information, the “settling” time period, and the product information, the label printing system 2 prints, based on the received information, a second label illustrated, for example, in FIG. 13. The printed second label is attached to the product 5 by, for example, a sales clerk, and the product 5 is displayed in a store.

When the product 5 with the second label attached is picked up by a customer visiting the store, brought to the cash register, and scanned through the POS system 3, the POS system 3 reads out bar-code information in the second label to obtain the “settling” time period of, and the product information on, the product 5. As the product information, the POS system 3 uses information stored in an internal storage apparatus inside the POS system 3 or an external storage apparatus.

The POS system 3 compares the read out “settling” time period and a current time to check whether the “settling” time period has elapsed. If the “settling” time period has not elapsed yet, the POS system 3 issues a warning. If the warning is not cancelled, the POS system 3 does not permit a casher to sale the product 5. The warning is canceled with, for example, an operation button on the body of the POS system 3.

If the “settling” time period has elapsed or the warning for the “settling” time period is cancelled, the POS system 3 compares the read out sales time period and a current time to check a sell-by time. If the product is within the sell-by time, the product is allowed to be on sale. If the product is out of the sell-by time, the POS system 3 issues a warning and does not permit a casher to sale the product.

As can be seen, the heated product sales system 10 issues a permission to sell the product after a certain time period has passed since the end of heating the product. Such a feature makes it possible to reduce the risk of selling the product whose temperature unevenly distributes immediately after the heating and has not uniformly distributed yet, and to improve quality of the product.

Moreover, the heating system and the sales system are separated from each other. Such a feature makes it possible to downsize each system to be placed in a retail store.

Moreover, the heated product sales system 10 shares heating information of a heated product, reducing the risk that an unheated product is inadvertently to be sold.

Moreover, the second label is printed with at least one or more of the information items; namely, the time period from the end of heating until the temperature of the product is uniformly distributed (the “settling” time period), the heating end information, the information indicating an elapse of the “settling” time period, and the salable time period from the end of the “settling” time period or the time when the salable time period ends. Such a feature makes it possible to reduce the risk that the retail store sells an unheated product or a product whose temperature unevenly distributes immediately after the heating and has not uniformly distributed yet, and to improve quality of the product. Furthermore, a customer can make sure approximately what time the unevenly distributed temperature immediately after the heating is uniformly distributed, contributing to determining the right time to eat.

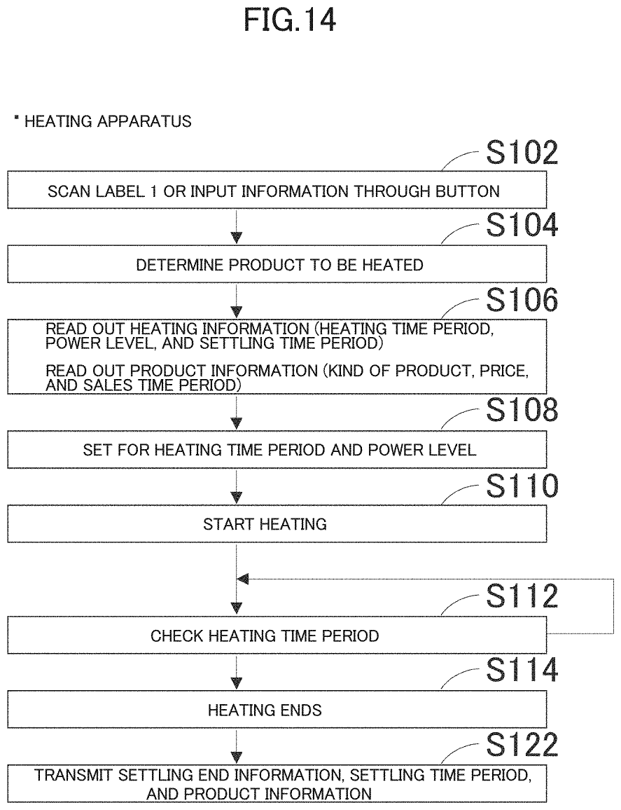

More specifically, as illustrated in FIG. 14, the CPU 110 of the heating apparatus 1 in this embodiment executes the processing below. The CPU 110 obtains information on a product to be heated from the first label through the controller 140 or using a bar-code reader (Step S102). Based on the obtained information, the CPU 110 identifies a kind of the product 5 (Step S104).

The CPU 110 identifies a heating time period and a power level for the product 5 with reference to the heating information table 121, and reads out various kinds of information on the product 5 with reference to the product information table 123 (Step S106). The CPU 110 sets the microwave oscillator 190 for the heating time period and the power level (Step S108). The CPU 110 causes the microwave oscillator 190 to start heating (Step S110).

Until the heating time period ends, the CPU 110 controls the microwave oscillator 190 (Step S112). When the heating time period ends, the CPU 110 causes the microwave oscillator 190 to stop heating (Step S114). The CPU 110 informs the POS system 3 and the label printing system 2 through the communication interface 160 of the time when the heating and cooking ends, the “settling” time period, and the product information (Step S122).

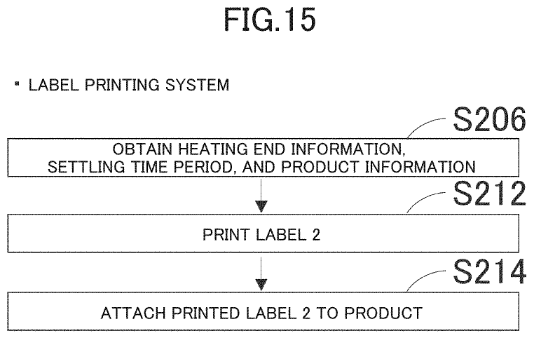

Described next is information processing on the label printing system 2 according to this embodiment. As illustrated in FIG. 15, the CPU 210 of the label printing system 2 obtains the heating end information, the “settling” time period, the “settling” end time, and the product information from the heating apparatus 1 through the communication interface 260 (Step S206). Based on the information, the CPU 210 causes the printer 290 to print the second label with such information as the “settling” time period, the “settling” end time, and the product information (Step S212). With reference to the information from the heating apparatus 1 and the product information table 123, the CPU 210 also prints the salable time period of the product. The sales clerk attaches the printed second label to the product 5 with the heating completed (Step S214).

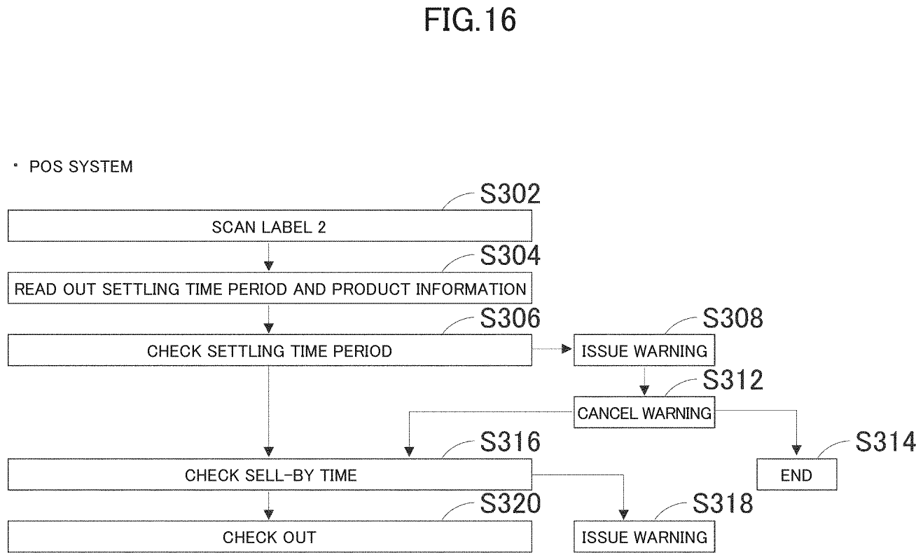

Described next is information processing on the POS system 3 according to this embodiment. As illustrated in FIG. 16, the CPU 310 of the POS system 3 reads the bar code of the second label through the bar-code reader 380 (Step S302) to obtain the “settling” time period, the “settling” end time, and the product information on the product 5 (Step S304).

The CPU 310 determines whether the “settling” time period ends (Step S306). If the “settling” time period has not ended yet, the CPU 310 causes the display 330 to issue a warning message, and the speaker 370 to output a warning tone (Step S308).

Here, through the controller 340, the CPU 310 receives a command to cancel the warning (Step S312). The CPU 310 causes the display 330 and the speaker 370 to stop issuing the warnings, and proceeds to a check of the salable time period (Step S316). Such a feature makes it possible to quickly check out the product when the customer is in a hurry even if the product is unevenly heated. Note that the sales clerk can stop selling the product without cancelling the warning (Step S314), and repeat the sequence again from the heating.

If the “settling” time period has already elapsed, the CPU 310 determines whether the salable time period or the sell-by time of the product 5 has passed with reference to the product information table 123 and the information read from the bar code (Step S316).

If the salable time period has passed, the CPU 310 causes the display 330 to issue a warning message on the display 330, and the speaker 370 to output a warning tone (Step S318).

If the salable time period has not passed yet, the CPU 310 accepts the purchase of the product 5 so that the check-out of the product 5 ends (Step S320).

### Third Embodiment

The operation of the heated product sales system 10 shall not be limited to those in the first and second embodiments. In a third embodiment, the product 5 whose “settling” time period has elapsed is provided with the second label indicating that the “settling” time period has elapsed, and allowed to be on sale. Described below is the third embodiment with reference the “flow 3” in FIG. 2. The third embodiment is different in flow of the processing from the first embodiment. Note that the configurations of the heating apparatus 1, the label printing system 2, and the POS system 3 in the second embodiment are the same as those in the first embodiment, and the descriptions thereof shall not be repeated.

First, a kind of the product 5 is determined, using a bar-code reader connected to the heating apparatus 1 to read the first label including the information on the kind of the product. In the determination, the heating apparatus 1 uses information on the product stored in an internal storage apparatus inside the heating apparatus 1 or an external storage apparatus.

Then, depending on the determined kind of the product 5, the heating apparatus 1 reads out: heating information including, for example, a heating time period, a power level, and a “settling” time period of the determined product; and product information including a kind, a price, and a sales time period of the product. As the heating information and the product information, the heating apparatus 1 uses information stored in an internal storage apparatus inside the heating apparatus 1 or an external storage apparatus.

The heating apparatus 1 sets a timer for the read out heating time period, and heats the product 5 with the read out power level. When the heating time period elapses, the heating apparatus 1 stops heating, and transmits heading end information, the “settling” time period, and the product information to the label printing system 2. The information may be transmitted either through wire or wirelessly.

Next, the label printing system 2 compares the heating end information and the “settling” time period sent from the heating apparatus 1 with a current time to check whether the “settling” time period has elapsed. If the “settling” time period has not elapsed yet, the label printing system 2 issues a warning. If the warning is not cancelled, the label printing system 2 does not allow for the print of the second label. The warning is canceled with, for example, an operation button on the body of the label printing system 2.

If the “settling” time period has elapsed or the warning for the “settling” time period is canceled, the label printing system 2 prints the second label illustrated, for example, in FIG. 3. The second label is printed with the “settling” end time and the salable time period. The printed second label is attached to the product 5 by, for example, a sales clerk, and the product 5 is displayed in a store.

When the product 5 with the second label attached is scanned through the POS system 3, the POS system 3 reads out product information from the second label. As the product information, the POS system 3 uses information stored in an internal storage apparatus inside the POS system 3 or an external storage apparatus.

The POS system 3 compares the read out sales time period with a current time to check a sell-by time. If the product is within the sell-by time, the product is allowed to be on sale. If the product is out of the sell-by time, the POS system 3 issues a warning and does not permit a casher to sale the product.

As can be seen, the heated product sales system 10 issues a permission to sell the product after a certain time period has passed since the end of heating the product. Such a feature makes it possible to reduce the risk of selling the product whose temperature unevenly distributes immediately after the heating and has not uniformly distributed yet, and to improve quality of the product.

Moreover, the heating system and the sales system are separated from each other. Such a feature makes it possible to downsize each system to be placed in a retail store.

Moreover, the heated product sales system 10 shares heating information of a heated product, reducing the risk that an unheated product is inadvertently to be sold.

Moreover, the second label is printed with at least one or more of the information items, namely, the time period from the end of heating until the temperature of the product is uniformly distributed (the “settling” time period), the heating end information, the information indicating an elapse of the “settling” time period, and the salable time period from the end of the “settling” time period or the time when the salable time period ends. Such a feature makes it possible to reduce the risk that the retail store sells an unheated product or a product whose temperature unevenly distributes immediately after the heating and has not uniformly distributed yet, and to improve quality of the product. Furthermore, a customer can make sure approximately what time the unevenly distributed temperature immediately after the heating is uniformly distributed, contributing to determining the right time to eat.

Specifically, the information processing on the heating apparatus 1 according to this embodiment is the same as that in the second embodiment, and thus shall not be repeated.

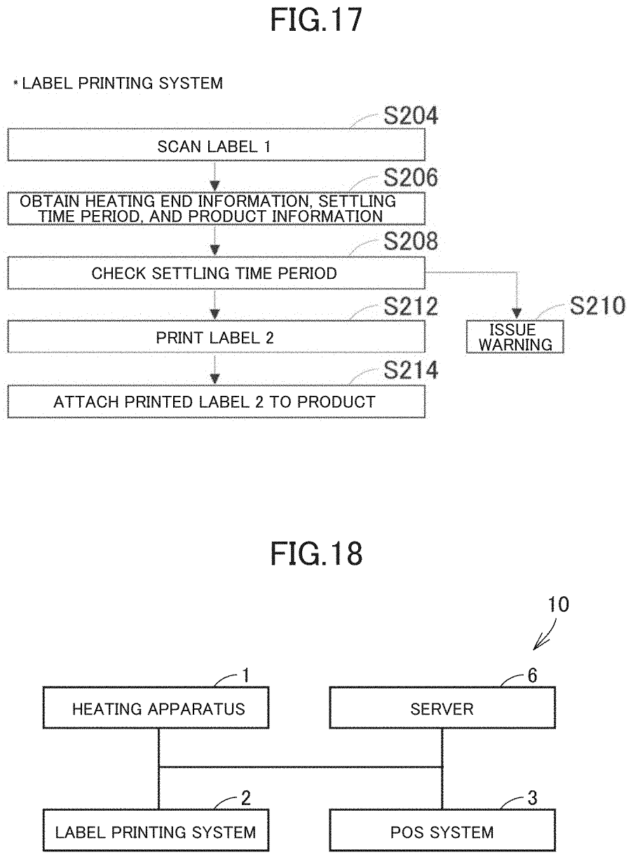

Described next is information processing on the label printing system 2 according to this embodiment. As illustrated in FIG. 17, the CPU 210 of the label printing system 2 causes, for example, the bar-code reader 280 to read the first label attached to the product 5 (Step S204). The CPU 210 obtains the heating end information, the “settling” time period, the “settling” end time, and the product information from the heating apparatus 1 through the communication interface 260 (Step S206).

Based on the “settling” time period and a current time, the CPU 210 determines whether the “settling” time period ends (Step S208). If the “settling” time period has not ended yet, the CPU 210 causes the display 230 to issue a warning message, and the speaker 270 to output a warning tone (Step S210).

If the “settling” time period has elapsed, or the warning of the incomplete “settling” is cancelled through the controller 240, the CPU 210 causes the printer 290 to print the product information on the second label (Step S212). With reference to the product information table 123, the CPU 210 also prints the salable time period of the product on the second label. The sales clerk attaches the printed second label to the product 5 with the heating and the “settling” completed (Step S214).

The information processing on the POS system 3 according to this embodiment is the same as that in the first embodiment, and thus shall not be repeated.

### Fourth Embodiment

The roles of the apparatuses included in the heated product sales system 10 according to the embodiments may partially or entirely be performed by other apparatuses. For example, as illustrated in FIG. 18, the roles of the heating apparatus 1, the label printing system 2, and the POS system 3 may partially be performed by such an apparatus as a server 6 in the cloud.

### Fifth Embodiment

Other than the heating technique by microwave, the heating apparatus 1 may utilize such heating techniques as the high-frequency dielectric heating and heating with a heater.

### SUMMARY

The above embodiments provide a heated product sales system including: a first apparatus heating and cooking a product; and a second apparatus suspending a sale of the product until a certain time period has elapsed after the heating and cooking.

Preferably, the second apparatus may include a register having a controller canceling the suspension of the sale of the product.

Preferably, the heated product sales system may further include a third apparatus printing a label for the product.

Preferably, the third apparatus may print the label with a time period from an end of the heating and cooking of the product until the product has a uniform temperature distribution.

Preferably, the third apparatus may print the label with at least one of information items including: an information item indicating that the heating and cooking of the product has ended; and an information item indicating an elapse of a time period lasting until the product has a uniform temperature distribution.

Preferably, the third apparatus prints the label with at least one of information items including: an information item indicating a salable time period of the product starting at an elapse of a time period lasting until the product has a uniform temperature distribution; and an information item indicating a time when salable time period ends.

The embodiments disclosed herein are examples in every respect, and not limiting of the present disclosure. The scope of the present disclosure is defined not by the descriptions above but by the scope of claims, and is intended to include all the modifications within the scope of the claims along with the their full scope of equivalents.

What is claimed is:

1. A heated product sales system comprising:
a first apparatus configured to heat and cook a product; and
a second apparatus configured to suspend a sale of the product until a certain time period has elapsed after the heating and cooking.

2. The heated product sales system according to claim 1, wherein
the second apparatus includes a register having a controller configured to cancel the suspension of the sale of the product.

3. The heated product sales system according to claim 1 further comprising a third apparatus configured to print a label for the product.

4. The heated product sales system according to claim 3, wherein
the third apparatus prints the label with a time period from an end of the heating and cooking of the product until the product has a uniform temperature distribution.

5. The heated product sales system according to claim 3, wherein
the third apparatus prints the label with at least one of information items including: an information item indicating that the heating and cooking of the product has ended; and an information item indicating an elapse of a time period lasting until the product has a uniform temperature distribution.

6. The heated product sales system according to claim 3, wherein
the third apparatus prints the label with at least one of information items including: an information item indicating a salable time period of the product starting at an elapse of a time period lasting until the product has a uniform temperature distribution; and an information item indicating a time when salable time period ends.
